(19) United States
(12) Patent Application Publication
(10) Pub. No.: US 2023/0174348 A1
(43) Pub. Date: Jun. 8, 2023

(54) Transport Hook

(71) Applicant: Christian Stampfer, Oberndorf (AT)

(72) Inventor: Christian Stampfer, Oberndorf (AT)

(21) Appl. No.: 17/917,275

(22) PCT Filed: Apr. 1, 2021
(86) PCT No.: PCT/EP2021/058668

§ 371 Date: Oct. 6, 2022

(30) Foreign Application Priority Data
Apr. 6, 2020 (AT) A50294/2020
Sep. 9, 2020 (DE) 10 2020 123 514.3

(51) Int. Cl. B66C 1/66; B66C 1/14; B66C 1/36

(52) U.S. Cl. CPC B66C 1/66; B66C 1/14; B66C 1/36

(57) ABSTRACT

The present invention relates to a transport hook for lifting and moving a load, wherein the transport hook (1) comprises a lever portion (2) with a coupling element (4) with which the transport hook (1) can be connected to a lifting device, and comprises a hook shank (3) which can engage in a hole (102) of the load (101) for lifting and moving the load (101.The hook shank (3) is connected with an angle section (14) to the lever portion (2) in such a way that an angle (o) between a line extending from the coupling element (4) to a vertex (SP) of the angle section (14) and a line extending along the hook shank (3) that is smaller than 90°.The hook can be used to pick up a load on an upwardly facing surface through a small opening and lift it securely. The transport hook can be provided with different locking elements that safely prevent the transport hook from being accidentally released.

The invention relates to a transport hook for lifting and moving a load, such as floor elements, which are placed close together and are only accessible from above.

Within the space, it is difficult to lift and move containers, frames, prefabricated parts, parts of module constructions or other objects, such as machines, which are or have to be installed in such a way that they cannot be picked up from the side or at the rear side. Here it would be advantageous if the containers etc. could be connected to the lifting device simply but securely on the surface facing a lifting device.

A floor covering support structure is known from the US 2008/0292397 A1 comprising a multitude of longitudinally aligned boards that are attached to each other. The floor covering support structure comprises at least two coupling openings in the form of elongated holes extending parallel to each other at a predetermined distance. Alternatively, the double hook can engage laterally with the floor covering support structure. A double hook can engage the interior of the floor covering support structure through the holes, and the double hook can be connected to a lifting device.

The US 9,741,847 B2 discloses an industrial mat comprising a support structure and two holes. The holes can be used to carry the industrial mat. Other known tools for lifting panel-shaped elements include channel hooks or tong-shaped tools to pick up the panel-shaped element at the outer face.

The US 845,724 discloses a pin-shaped element attached to a base for insertion into a drilled hole of a block of stone. Frictionally engagement in the drilled hole allows the stone block to be lifted. The base protrudes laterally over the pin and supports itself against the surface of the stone block. This creates a wedge.

A transport hook discloses from DE 10 2016 222 787 A1 that can be inserted through a hole and engages behind the edge of this hole by means of a safety device.

US 1,373,438 discloses a self-locking lifting device for lifting stone blocks. This comprises a pin-shaped structure to which a bracket is attached at a right angle. A clamping lever is pivotally attached to the bracket. A coupling element for attaching a rope is provided at one end of the clamping lever. The other end of the clamping lever comprises an edge that is pressed against the surface of a stone block when the pin-shaped section is inserted into a corresponding hole in the stone block.

It is the task of the invention to provide a transport hook and a lifting system with which a load can be safely picked up, lifted and moved within the space without danger. A further task is to provide a suitable procedure.

These tasks are solved by the objects of the independent patent claims. Advantageous embodiments are specified in the subclaims.

A first aspect relates to a transport hook for lifting and moving a load with a plate-shaped section in which a hole is formed, the transport hook comprising a lever section with a coupling element via which the transport hook can be connected to a lifting device, and a hook shank, the hook shank is connected with an angle section to the lever portion in such a way that an angle between a line that extends from the coupling element to a crest of the angle section that is arranged on the inner surface of the angle section and a line that runs along the hook shank that is smaller than 90° and preferably smaller than 85°. The hook shank and angle section form a continuous strand of approximately uniform thickness, so that, for lifting and moving the load, the hook shank and angle section can engage the hole of the load and the hook shank engages behind the edge of the hole.

Because the angle is smaller than 90°, the hook can also be pulled in a direction that is oblique to the surface of a load and it is nevertheless ensured that the hook shank engages behind the load in such a way that the hook cannot come loose when tension is applied.

The design of the hook from a strand of approximately uniform thickness in the area of the hook shank and the angle section allows the hook shank and at least part of the angle section to be inserted into the hole, so that the hook shank engages an edge of the hole.

Preferably, the hook shank is approximately rectilinear in shape. By “approximately rectilinear” is meant a rectilinear design or a curved design of the hook shank, which is, however, curved to a substantially lesser extent than the angle section. The radius of such a curved hook shank is at least half the length of the lever portion, and in particular at least the entire length of the lever portion. Due to the approximately linear formation of the hook shank, the hook shank itself can be designed as long as desired, in order to be able to reliably engage behind even larger holes at the edge and at the same time to be reliably inserted into a hole of an approximately flat plate, which extends on all sides around the hole by at least a distance corresponding to the length of the lever portion. In the case of a strongly curved lever portion, there would be a problem that due to the curvature and extension of the lever portion, the hole in the plate would have to be very large in order to be able to insert the hook section, whereby a secure hold would not be achieved, or the hook section would not fit through the hole due to its curvature. In this connection, it should be taken into account that in the case of plates with a large surface, in which the hole for engagement cannot be arranged at the edge, the lever portion can be arranged approximately parallel or only with a slight angle of inclination to the surface of the plate-shaped section. The hook according to the invention can also be used to reliably lift bodies with a plate-shaped section comprising a large surface area, whereby the corresponding hole need only be slightly larger than the cross-sectional area of the hook section or angle section.

The angle can be less than 80° and, in particular, lie in the range of about 75°.However, it should not be less than 60°, preferably not smaller than 70°, otherwise the thickness of the load to be carried is very limited.

A second aspect relates to a transport hook for lifting and moving a load, the transport hook comprising a lever portion with a coupling element via which the transport hook can be connected to a lifting device, and a hook shank which can engage through a hole of the load, wherein at least the hook shank is at least partially a round component with a substantially round cross-section.

The round component comprising a substantially round cross-section is formed thereby to be substantially free of edges, so that it can rotate freely around a hole axis without canting therein.

Thus, because the hook shank is formed as a round component, canting cannot occur even when the hook is rotated in the hole of the load around an axis that is approximately perpendicular through the center of the hole. As a result, the hook can be arranged as required when inserted into the hole of the load and aligns itself automatically when tensile stress is applied to lift the load.

The essentially circular cross-section of the round component can be an oval cross-section and in particular an exactly circular cross-section. This means that the round component comprises no edges that could cant to non-circular holes in the load.

The coupling element can be comprised as a coupling aperture on the lever portion, in particular at the end of the lever portion remote from the hook shank, and serves to attach a means of pulling, such as a rope or a chain, with which the hook can be pulled, for example, by means of a lifting device, such as a crane, in order to lift a load. Instead a coupling aperture, any other coupling means for connecting the hook directly or indirectly via a pulling means to a lifting device may also be provided.

The coupling aperture or other coupling means is preferably inserted in or connected to an upper surface of the load facing the lifting device.

The hole in the load can be circular or oval, for example. In particular, the hole may be a substantially circular through hole that can be easily inserted into the load, even subsequently, for example with a manual milling cutter. The load may be a floor covering, for example of an event tent, the floor covering preferably being made of wood or a plastic, a hollow part, a frame or another load, such as a machine that has a hole in an upper surface facing the lifting device or in which a corresponding hole is subsequently inserted.

A diameter of the hole depends on the weight of the load. Basically, the larger the load, the larger the diameter of the transport hook, since the dimensions of the transport hook are also determined by the weight of the load to be lifted and carried. It applies that the smaller the load, the smaller the transport hook and the hole can be designed. This means that a hole diameter of the hole in the load and a material thickness and/or the material of the transport hook can be matched and adapted to the weight of the load to be lifted.

Surprisingly, it has been shown that relatively small holes with a maximum diameter of no more than 2 cm, in particular no more than 1.8 cm or no more than 1.5 cm, are sufficient to carry heavy loads. This allows the holes to be inserted into the floor coverings of transportable floors without creating a tripping hazard.

The hook shank is preferably formed to be essentially rectilinear. The hook shank is connected to the preferably approximately rectilinear lever section by a curved angle section.

Preferably, the hook shank, the angle section and an adjacent engagement area of the lever portion have substantially the same cross-sectional shape for engaging in and through the hole of the load.

In one embodiment, the hook shank may include an elongated free fuse end extending from the intervention section at an angle. The free fuse end extends in a direction away from the lever portion, and can thus increase an overall length of the transport lever. The intervention section and the free fuse end form a kind of double leading edge, which prevents the transport hook that is still free from the load from falling out of the hole of the load or being pulled out of the lifting device. The free fuse end is preferably connected to the intervention section in such a way that a relative movement between the two parts is not possible.

In this case, the hook shank with or without a free fuse end can in particular be formed in one piece, i.e. it does not consist of several parts that are joined together, for example glued or welded. The same applies to the lever portion. The hook shank and lever portion can then be connected to each other in a material-locking, form-fitting and/or force-fitting manner to form the transport hook. It is preferable if the transport hook, consisting of the lever portion and the hook shank, is formed in one piece as a whole or originally is molded in one piece.

Methods for primary shaping parts include, for example, metal or plastic casting, powder pressing with or without subsequent sintering, machining from a solid material, such as sawing and milling, or forging from a corresponding semi-finished product. Any of these techniques can be used alone to form the transport hook. However, two or three of these techniques can also be used to complete the transport hook, for example, the rough shape of the transport hook can be cut out from a plate material using a laser or another method, and then the hook shank can be forged. After the transport hook has been manufactured with at least one of the processes, post-treatments can be carried out, for example, the removal of sharp edges, hardening, grinding or at least the coating of the surface at least partially. Metals, such as steel or iron, or a reinforced plastic that is similar resilient to steel or iron, can be used as a material. For special applications where large weights do not have to be lifted and transported, a light metal or light metal alloy can also be considered as a material.

The lever portion of the transport hook may be substantially plate-shaped. The lever portion can have a length that is many times greater than a width or thickness of the lever portion. The length, width and thickness of the lever portion can be chosen by the expert according to the task.

A free end of the hook shank can be rounded at the edges or overall and in particular may be substantially semicircular in shape. The cross-section is preferably substantially circular, but can also be oval or has rounded corners with substantially straight intermediate areas between the rounded corners. The same applies – mutatis mutandis – to the optional free fuse end, which can be of conical design with a diameter that tapers into the direction in which the free fuse end extends, starting at the engagement element.

The circumferential shape of the hook shank or the connection section and/or angle section and/or engagement section preferably has no sharp edges and allows easy engagement in or through the hole. The round cross-section advantageously avoids causing damage to the edges of the holes when the transport hook is pressed against the edges of the hole.

The diameter of the engagement area and/or the angle section and/or the hook shank and/or the optional free fuse end of the hook shank can/may essentially correspond to the thickness of the plate-shaped lever portion. Depending on the task and the load to be carried, the specified diameter can also be smaller or larger than the thickness of the lever portion.

A width of the lever portion at the free fuse end remote from the hook shank may be greater than a width of the lever portion adjacent to the engagement area. For example, the lever portion may be 1.5 times or 2 times wider at the free end than at the engagement area.

At the end facing the hook shank, the lever portion may have a transition region in which, like the hook shank, it is round with a diameter corresponding substantially to the diameter of the hook shank. To prevent the hook shank from entering the hole in the load beyond this transition region, the lever portion may have wings projecting laterally from the lever portion so that the lever portion has a width in the region of the wings that is greater than the average diameter of the lever portion, for example twice the diameter of the lever portion in this region.

The hook can comprise two preferably identically shaped wings that are connected to the lever on opposite sides of the lever portion, consequently forming a right wing and a left wing. In this case, the wings are connected to the lever portion, for example welded, glued or otherwise preferably non-detachable connected, in particular on a lower side of the lever portion facing the hook shank. Alternatively, the wings can be formed in one piece as a wing element that is connected to the lever portion, for example in a coupled or firmly bonded manner.

The wing element, respectively the upper surface of the wing element facing away from the lever portion, may protrude beyond the surrounding outer surface of the lever portion, or in the connected state, be flat with the surface of the hook, which means that the wing element does not protrude from the lever portion, but is located in a receptacle formed by the lever portion for the wing element, flush with the surrounding lever portion. Finally, the lever portion may have a receiving slot for the wing element, into which the wing element is inserted and secured, for example glued or attached with a screw. The same applies – mutatis mutandis – to the right and left wings.

The wings or wing element have a length extension or span transverse to a central longitudinal axis of the lever, selected to increase, for example approximately double, the diameter of the lever portion in the region of the wings or wing element. The cross-section of the wings or wing element can be arbitrary, with rounded edges to avoid damaging to the hole. Preferably, the wings or the wing element have a substantially round, for example oval-, drop- or elliptical-shaped diameter, at least in the areas protruding from the lever portion. The diameter may be constant over the length of the wing or wing element, or may change continuously or in sections in the longitudinal and/or transverse direction of the wing or wing element. The front end of the wings or wing element facing the hook shank may protrude from the lever portion or the surface of the lever portion, respectively, at an angle of 90° to 110°. When viewed from above, the wings may comprise a peripheral shape that is substantially quadrangular or triangular, or the wing element comprises have a peripheral shape that is essentially in the shape of a segment of a circle or triangular. A distance from the front end of the wings or wing element to a tangent in the longitudinal direction of the hook at the front end of the hook can be approximately twice as large as a diameter of the hook shank in the area of the engagement section. The distance can also be larger or smaller.

The lever portion of the transport hook is preferred to be many times longer than the hook shank. In particular, the lever portion is at least 2.5 times and in particular at least 3 times and preferably at least 4 times as long as the hook shank. The longer the lever portion, the more stable the engagement of the hook in the hole.

The length of the hook shank HSL is preferably at least 2 cm, in particular at least 3 cm and preferably at least 4 cm.

The free end of the lever portion facing away from the hook shank is preferably adapted to be connected to the lifting device, for example a crane. For this purpose, the free end can be formed in the shape of an eye, or at least one coupling opening can be inserted in the surface of the lever portion, through which, for example, a rope or a chain can be passed. The free end can also be in the form of a spring safety hook or any other known connecting element suitable for the purpose, connected or joined to the free end of the lever portion.

The transport hook may further comprise a locking element that secures the hook shank in the hole, at least when the transport hook is not loaded with the weight of the load. For example, the locking element can be a protection flap that is connected in a swivel joint to the hook shank, for example in the engagement section or the angle section. It can preferably be elastically preloaded into a locking position, in which it projects from the hook shank at an angle, or into a release position, in which the locking element is inactive, that is, preferably rests against the hook shank in a form-fitting manner. The elastic tension can be generated, for example, by an elastic element such as a compression or tension spring. When the locking element is in positive contact with the hook shank, the surface of the locking element facing away from the structure of the hook shank preferably forms the surface of the hook shank. This means that the locking element in contact with the hook shank does not protrude from the hook shank, but is located in a receptacle formed by the hook shank for the locking element, flush with the surrounding hook shank.

Before the hook shank or at least the engagement section is guided through the hole, the locking element pretensioned into the locking position can be pressed into the release position against elastic force with, for example, the thumb until the locking element lies in the hole with the front end facing the hole. The thumb can then release the locking element, which is now held in the hole in the release position or an intermediate position between the release position and the locking position. Once the hook shank has passed sufficiently far through the hole, the elastic element can push the locking element completely into the locking position in which it is held by tensile force acting on the locking hook on the lever portion when the load is lifted. To release the locking device, the locking element must be moved back into the release position and held there until, when the transport hook is pulled out of the hole, it is back in the hole to such an extent that the edge of the hole, which slides over the locking element when the transport hook is pulled out, the locking element can press into the release position.

A further aspect of the invention relates to a transport hook for lifting and moving a load, the transport hook comprising a lever portion with a coupling element via which the transport hook can be connected to a lifting device, and a hook shank which can engage through a hole of the load, wherein the hook shank is connected to the lever portion with an angle section. This transport hook is characterized by a safety device comprising a locking part movably arranged on the transport hook in such a way that it can form a protrusion on the hook shank so that a hook shank passed through a hole can no longer escape from the hole.

The protrusion formed by the locking part can thus, in use, be arranged on the other side of the load from the coupling element of the hook on which the lifting device can engage, so that because of the protrusion the hook shank does not fit through the hole and be pulled out of it. Typically, this protrusion is located on rear side of the section of the load in which the hole is formed.

However, the locking part can also be located on the same side of the load as the coupling element of the hook when used. Such a locking part is arranged on the lever portion and may form a protrusion thereon which extends from the lever portion in the same direction as the hook shank. This keeps the side of the lever portion facing the hook shank at a distance from the surface of the load. As a result, the hook shank engages behind the edge of the hole and the transport hook cannot be removed from the hole.

The locking part is preferably loaded by means of a spring so that it can be moved against the resilience in such a way that it does not form a protrusion on the hook shank and the latter can be pulled out of the hole.

The locking part preferably comprises a locking rod which is mounted on the transport hook so that it can be moved, in particular longitudinally.

The lever portion of the transport hook can contain a retaining bracket that is used to retain the safety device.

The retaining bracket can be integrally formed or formed in one piece with the transport hook and in particular on the lever portion, with the meaning of “one piece” already explained above for the transport hook. The retaining bracket can be a separate part that can be joined to the lever portion, for example, by positive, force and/or material locking.

The safety device can comprise a mounting plate that can be used to attach it to the retaining bracket. The movably mounted locking part consists of a locking rod and other parts with which it is spring-loaded in the retaining bracket. In particular, these parts comprise a handle that can be used to operate the locking part.

The retaining bracket can also be plate-shaped, with a passage hole for the locking rod, the retaining bracket forming a stop for the mounting plate of the safety device. A spring element that preferably pretensions the safety device into a locking or resting position is supported with one end on an outer side of the retaining bracket facing away from the mounting plate and with the other end on an end of the handle facing the retaining bracket. This means that the spring element, for example a compression or tension spring, is freely accessible outside the retaining bracket. The spring element can be protected from contamination by an elastic compressible or expandable sleeve.

The transport hook can have a through hole in the area of the angle section, which forms a guide, preferably a linear guide for the locking part, in particular the locking rod. This means that the locking part extends from the mounting plate into the through hole in the transport hook in the area of the angle shank, can extend through the through hole and out of the through hole so that it protrudes from the hook shank and forms a securing projection. If the locking rod is arranged inside the through hole, the locking rod assumes its release position in which the transport hook can be released from or connected to the load; if it extends out of the through hole at an end facing away from the retaining bracket, it assumes the locking position in which it secures the transport hook in the hole.

In order to move the locking part from the locking position to the release position, the locking part can comprise the handle with which the locking part can be moved by hand against the force of the elastic element or spring to such an extent that a free end of the locking rod remote from the mounting plate lies within the through hole of the transport hook. In this release position, the locking rod can be fixed, for example, by means of a locking mechanism, so that the locking rod is advantageously protected from damage, for example, in storage or during transport of the transport hook to a location where it is used. This locking mechanism can be activated, for example, by rotating the locking part around its longitudinal axis using the handle. The locking mechanism can also be designed in such a way that the handle or other means can also be use to secure the locking part in the locking position, so that it cannot unintentionally move back to the release position.

To facilitate the production of the through hole in the region of the angle section, the hook can comprise a nose which, in the region in which the through hole is formed, protrudes from an outer surface of the hook in the manner of a dormer. The nose has a flat surface facing the retaining bracket that is substantially parallel to the retaining bracket. This facilitates drilling of the through hole as the drill can be placed on a flat plane.

The nose can be a separate part that is connected to the hook, preferably in a fixed manner or, less preferably, in a detachable manner. The nose can be formed together with the hook in one piece, with the same meaning as already explained for the hook. The nose advantageously extends the length of the through hole, so that the locking rod is guided over a greater length in the through hole and is thus protected against damage over the greater length.

The nose may have a surface facing the retaining bracket, which is shaped and sized to prevent the handle from being unintentionally actuated. Unintended actuation is understood to mean in particular an unintentional release of the locking part that is caused by force acting on the side of the handle facing away from the retaining bracket.

The nose may comprise a flat surface oriented substantially parallel to a central longitudinal axis of the lever portion and facing away from the lever portion. The nose can comprise an extension projecting upwardly, preferably at an angle, from the flat surface and configured to enlarge the side of the nose facing the handle with the drilling formed in it. The projection surface of the nose facing the handle is at least as large as the projection surface of the handle facing the nose. The projection surface of the nose covers the projection surface of the handle at least substantially, preferably completely.

The locking part can also be used to act on the locking element discussed above to pivot the locking element into the locking position. In this case, the locking element is elastically pre-tensioned into the rest position and can be moved into the locking position against the elastic pre-tensioning force by means of the telescopic locking rod and preferably held in the locking position. The locking part can be pre-tensioned into the telescoped position as described, so that the transport hook is double-secured in the hole. If the locking part is moved into the release position and preferably fixed in the release position, the locking element is elastically moved back into the release position so that the transport hook can be removed from the hole again. It is not necessary to reach under the load to remove the transport hook from the hole. If the locking part is secured in the locking position, the elastic recoil force of the locking element can also move the locking rod back to the locking position after the locking element has been released. In this case, the locking element secures the locking rod in the locking position.

If the load hangs under tension on the transport hook, the transport hook is received in the hole in a self-locking manner, i.e. the aforementioned locking devices primarily prevent the transport hook from being pulled out of the hole of the load before and during lifting of the load. Of course, they also secure the transport hook during lifting of the load, but in this case the transport hook is adequately secured in itself by the hook shank engaging behind the edge of the hole and by the transport hook being fixed in place by the hole of the load.

Another aspect of the invention relates to a lifting system for lifting and moving a load. The lifting system comprises a single or at least two transport hooks, comprising a lever portion and a hook shank, and a lifting device that is or can be connected to the transport hooks. Preferably, when using at least two transport hooks, the transport hooks are identically configured.

The transport hook(s) can in particular be transport hooks as explained above. Each of the transport hooks is preferably connected to a rope or chain in the lever portion. The ropes or chains are arranged at an end facing away from the transport hook so that they can be connected to a connecting element or a gripper of the lifting device.

Each of the transport hooks can be passed through a hole of a load with the hook shank and is secured in the hole by clamping as soon as the lifting device applies a tensile force to the transport hooks by lifting the load. Each of the transport hooks can comprise a locking element and/or a safety device that additionally secures the transport hook in the hole. The locking element or the safety device preferably concerns the safety devices described above.

The lifting system can comprise only a single transport hook that engages in a hole in the load. In the case of large, for example, flat or hollow components, it is advantageous if the lifting system comprises at least three, four or more transport hooks to prevent the load from tipping and/or rotating during setting down, lifting and transport.

A further aspect of the invention relates to methods for lifting and moving a load, for example, a hollow structure or molded tube, comprising at least one round hole within a top surface of the structure with a single or several transport hooks, in particular a transport hook as explained above, or with a lifting system, as shown above.

The transport hook comprises a hook shank and a lever portion. The hole in the load is preferably an approximately circular through hole, which can also be inserted into the load subseq uently.

To prepare for lifting, the hook shank of the transport hook can be partially inserted through the hole by hand. It may be necessary to manually move or push a locking part and/or locking element that is connected to the hook shank in a swivel joint and elastically pretensioned into a locking position into a release position in which the locking element does not protrude on the hook shank, so that the locking part and/or locking element is inserted into the hole with the hook shank in the first step and feed through the hole. In a second step, the transport hook is loaded with a tensile force, with a force vector that is substantially opposite to a direction of insertion of the transport hook into the hole, so that the hook shank is clamped in the hole, preferably an oval or circular hole.

The aspects explained above can each be used independently of each other or, as shown in the embodiment examples, in combination with each other.

In the following, the invention is explained in more detail with reference to figures. The figures show examples of the embodiments of a transport hook, without thereby limiting the scope to these embodiments.

The figures show in detail:

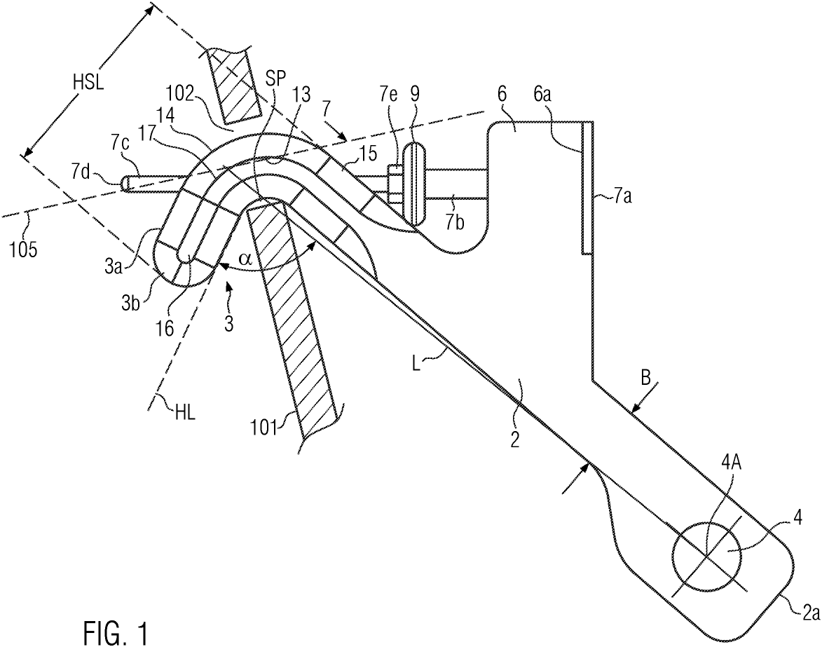

FIG. 1: Transport hook with safety device in a view from the side;

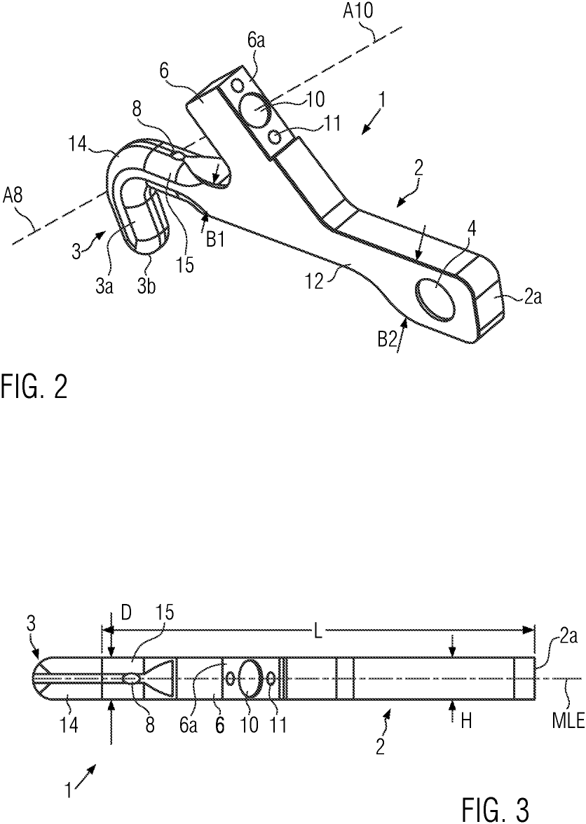

FIG. 2: Transport hooks of FIG. 1 without a safety device in a perspective view;

FIG. 3: Top view of transport hook of FIG. 2;

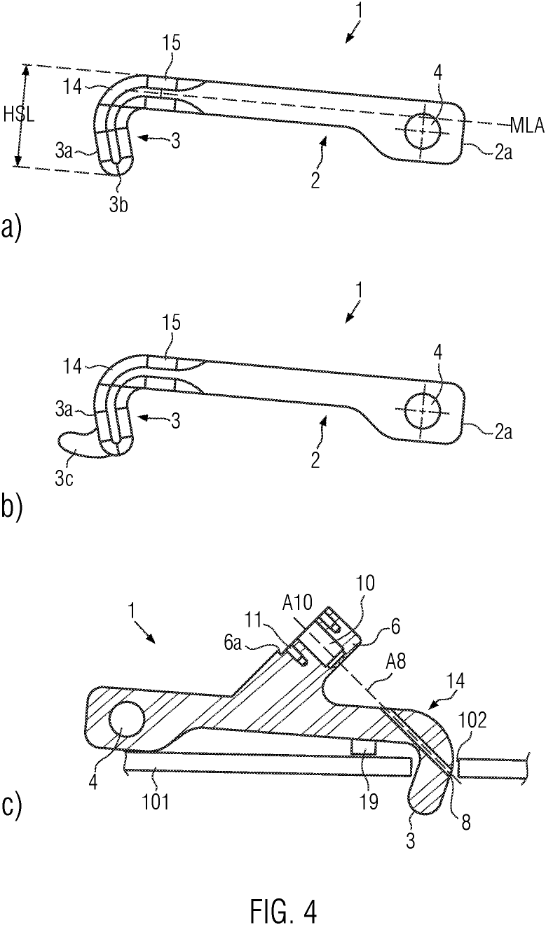

FIG. 4: Transport hook of FIG. 2 from the side and in a sectional view along a central longitudinal axis;

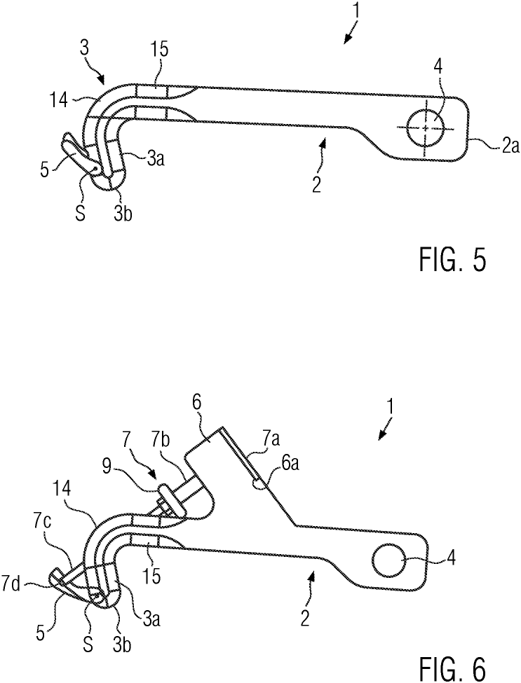

FIG. 5: Transport hook with locking element pretensioned into the locking position;

FIG. 6: Transport hook with locking element, which is pressed into the locking position and held there by means of the safety device;

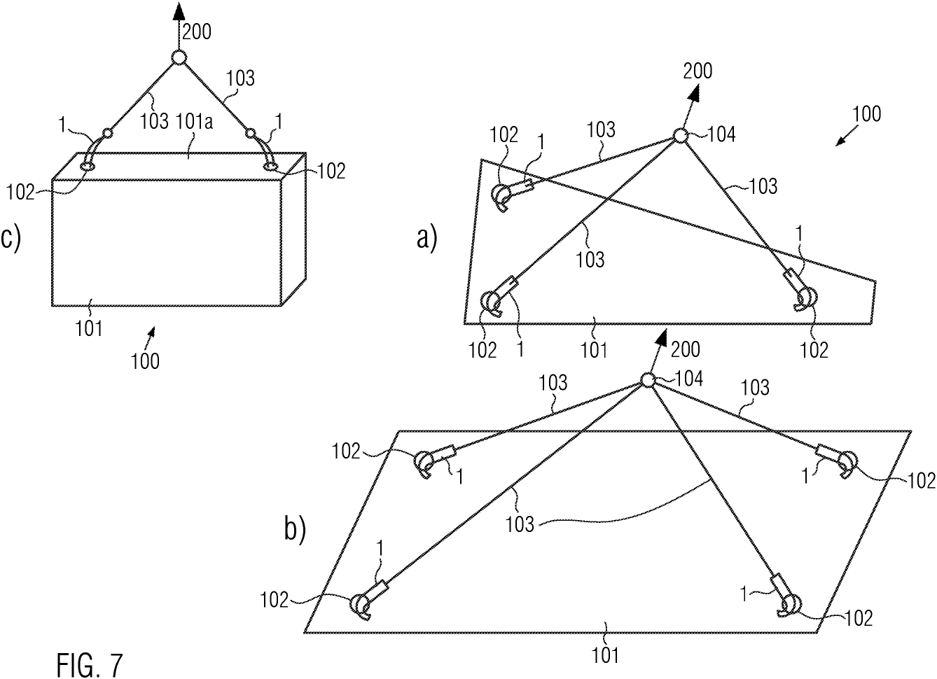

FIG. 7: Sketch of lifting system with two or three transport hooks;

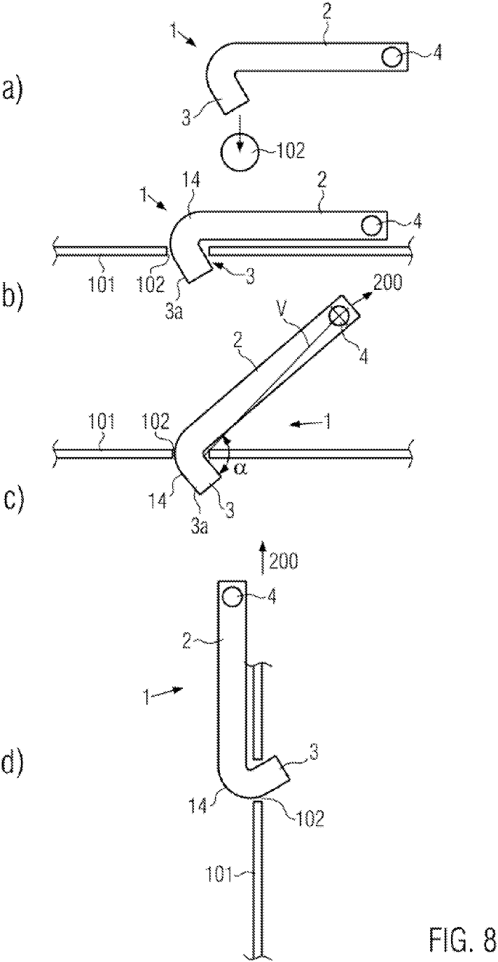

FIG. 8: Sketched representation of the process steps for gripping and lifting a load with a transport hook; and

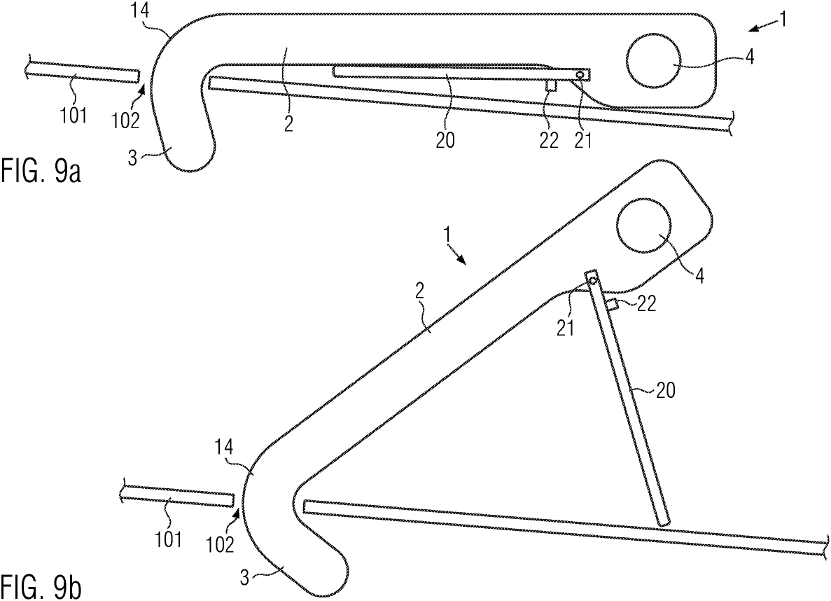

FIGS. 9a, 9b Transport hook with another locking element in the release position and the locking position;

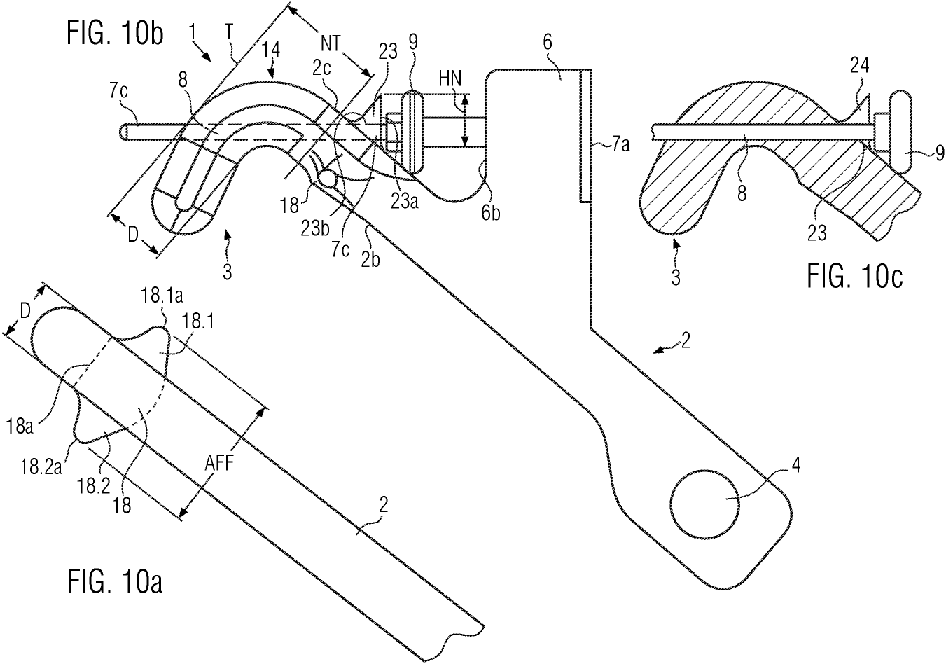

FIGS. 10a 10b, 10c Transport hook with safety device with wings and nose.

FIG. 1 shows a transport hook 1 with which a load 101, for example a floor element of an event tent, can be lifted.

The transport hook 1 comprises a lever portion 2, a hook shank 3 and a retaining bracket 6 connected to a safety device 7 that can secure the transport hook 1 in engagement with and in a partial pass through a hole 102 in the load 101.

The lever portion 2 has a free end 2a and a coupling opening 4, acting as coupling element, close to a free end 2a remote from the hook shank 3.Adjacent to the hook shank 3 is an angle section 14 connecting the hook shank and the lever portion 2.The angle section is bent so that the lever portion 2 and the hook shank 3 are arranged at an angle to each other.

The lever portion 2 has an engagement region 15 adjacent to the angle section 14, which has substantially the same cross-sectional shape as the angle section 14 and the hook shank 3 to engage a hole 102 of a load 101 in certain situations, as explained below.

In the present embodiment, the engagement region 15, the angle section 14 and the hook shank 3 comprise a roughly circular cross-section that has somewhat flattened lateral surfaces 16. Preferably, the cross-section is shaped to be substantially edge-free so that it is free to rotate in a hole 102 around a hole axis 105, which runs centrally through the hole 102 and is perpendicular to a plate-shaped portion of the load in which the hole 102 is made. Substantially free of edges means that only an obtuse angle of, for example, more than 100° and in particular more than 150° is formed at edges. With such edges, the risk of entanglement with protrusions formed at the edge of the hole is low. Thus, in the embodiment example shown in FIG. 1, the flattened surfaces 16 with the approximately circular surfaces in cross-section each form edges 17, which enclose such an obtuse angle that there is no danger of entanglement.

The hook shank 3 is comprised of an engagement section 3a and a free end 3b remote from the angle section, which has a blunt shape, e.g. in the form of a ball segment.

In the embodiment example, the transport hook 1 is formed as a one piece or formed from one piece. This means, for example, that the transport hook 1 has been cut out of a plate material, produced in a casting process, pressed from powder or forged from a semi-finished product.

The safety device 7 comprises a mounting plate 7a and a locking part, which in the present embodiment is formed of a hollow cylinder 7b and a locking rod 7c with a free end 7d.The locking part further comprises a handle 9 that is connected to the locking rod 7c.The hollow cylinder 7b has an internal thread and the rear portion of the locking rod 7c has an external thread, which are engaged each other. With a lock nut 7e, on the one hand, the disk-shaped handle 9 is fixed to the locking part and, on the other hand, the relative position of the locking rod 7c to the hollow cylinder 7b can be adjusted. This allows the length of the locking part to be adjusted and adapted to the size of the hole 102 of a load 101 to be lifted with the transport hook 1.

The hollow cylinder 7b is slidably mounted in a through hole 10 of the retaining bracket 6.A compression spring (not shown) is arranged in the through hole 10, which is supported on the mounting plate 7a and applies a force to the locking part 7b, 7c, 7e, which pushes the locking part away from retaining bracket 6.

The locking rod 7c is slidably mounted in a through-hole 8, which extends through the angle section 14 and joins on the side of the hook shank 3 remote from the retaining bracket 6, so that the locking rod protrudes with its free end 7d on the hook shank 3 in a locking position (FIG. 1).

The through holes 8, 10 are aligned with each other, i.e. a center axis A10 of the hole 10 coincides with a center axis A8 of hole 8.

In the present embodiment, the handle 9 also serves as a stop to limit the movement of the locking parts 7b, 7c, 7e between the locking position and a release position.

In the locking position, the locking pin 7c on the hook shank 3 protrudes with its free end 7d and the handle 9 strikes the lever portion 2 at the engagement region 15.In the release position, the locking pin 7c is fully retracted with its free end 7d into the through hole 8 of the transport hook 1 and the handle 9 strikes the retaining bracket 6.The locking part can thus extend and retract with respect to the through hole 10.

In this release position, the locking rod can optionally be fixed by means of a locking mechanism (not shown), so that the locking rod is advantageously protected from damage, for example, in storage or during transport of the transport hook to a location where it is used. This locking mechanism can be activated, for example, by rotating the locking part around its longitudinal axis using the handle 9.The locking mechanism can also be designed in such a way that the handle 9 or other means can also be use to secure the locking part in the locking position, so that it cannot unintentionally move back to the release position.

The mounting plate 7a can have a through hole through which the locking part protrudes backwards via the locking plate 7a in the release position. This through hole then forms a further linear guide for the locking part. In the present embodiment example, mounting plate 7a is designed without through-hole. As an alternative to the handle 9, the mounting plate can provide a stop for the locking part in order to limit its movement into the release position.

The angle section 14 connects the engagement region 15 with the hook shank 3 at an angle, wherein the angle in the embodiment is less than 90°.In other embodiments of the transport hook, the angle can be approximately 90° or 90°.A connecting line V that extends through a coupling point and a vertex SP of angle section 15.The coupling point is the connection point at which, for example, a lifting device engages to lift the transport hook 1.In the present embodiment, the coupling point is the center point 4A of the coupling opening 4 where the transport hook 1 can be connected to the lifting device 200.The vertex SP is arranged at the inner surface of the angle section. A hook line HL runs along the inner surface of the hook shank 3.The connecting line V and the hook line HL intersect at an angle α that is smaller than 90° and preferably smaller than 85° and in particular smaller than 80° or smaller than 75°.

The smaller the angle α is, the more strongly the hook shank 3 engages behind a plate-shaped portion of a load in which the transport hook 1 is hooked in a hole, and the less it is necessary to arrange the lever portion 2 perpendicular to the plate-shaped portion of the load.

The hook shank 3 may have a partial sheath or coating 13, which, for example, has a nonskid surface and/or is made of an elastic material to mitigate or prevent damage to the edges of the holes.

FIG. 2 shows the transport hook 1 of FIG. 1 in a perspective view without the safety device 7.FIG. 2 shows the through hole 10 within a receptacle 6a for the safety device 7, and attachment points 11 in which the mounting plate 7a can be connected to the transport hook 1, for example screwed or positively received via corresponding connection elements not shown. In addition, FIG. 2 shows the through hole 8 for the locking rod 7c.

In the embodiment, the lever portion 2 is designed as a flat structure, i.e. it has two flat side walls 12, which run essentially parallel to each other. The side walls 12 can also extend at an angle to each other so that a thickness H (FIG. 3) and/or a width B of the lever portion 2 changes over the length L or part of the length of the lever portion.

The lever portion 2 has a first width B1 directly adjacent its engagement section 15 and a second width B2 near the free end 2a, which is approximately twice the width B1.In the embodiment example, the transition from the first width B1 to the second width B2 is stepwise, but the widening of the lever portion 2 along its length can also be carried out continuously.

The enlarging is designed in such a way that it points to the same side as the hook shank 3.The center of the coupling opening 4 can be offset a bit from a central longitudinal axis MLA (FIG. 4a) of the remaining lever portion 2.In the present embodiment, the offset corresponds approximately to the radius of coupling opening 4.Since the offset with respect to the central longitudinal axis MLA is directed towards the side on which the hook shank 3 is arranged, the angle α between the connecting line V and the hook line HL explained above is smaller than without offset, whereby angular deflection or engaging behind by the hook shank 3 is more pronounced.

FIG. 3 shows the transport hook 1 of FIG. 2 viewed from above. The transport hook 1 of the embodiment comprises a substantially uniform thickness H along its entire length L. This means, a diameter D of the substantially round or circular hook shank 3 corresponds to the thickness of the flat lever portion 2.The thickness H may also vary, for example, be smaller at the free end 2a than near the connection section 3c.

The transport hook 1 is of mirrored design with reference to a central longitudinal plane MLE (MLE is perpendicular to the drawing plane of FIG. 3).This means that the transport hook 1 can consist of two cast or molded parts that are joined together, for example welded together. This allows through holes 8 and 10 to be formed in the respective halves, thereby saving reworking of transport hook 1.

The top view of FIG. 3 shows, as in FIG. 2, the through hole 8 for the locking rod 7c of the safety device 7, the through hole 10 and the attachment points 11.

FIG. 4 comprises a Figure a) showing the transport hook 1 in a side view, a Figure b) showing another embodiment of the transport hook 1 with a free locking end 3e on the hook shank 3, and a Figure c) showing a section through the transport hook 1 of Figure a) along the central longitudinal plane MLE and parallel to the side walls 12. The transport hook in Figure c) comprises an optional magnet 19, in particular a permanent magnet, which additionally secures the transport hook 1 in the hole 102 if the load 101 is made of magnetic metal or comprises a metal that is attracted by the magnet 19.

FIG. 4a is substantially the same as the illustration of the transport hook 1 in FIG. 1, only without the safety device 7.Reference is therefore made to the description of FIG. 1.

FIG. 4b shows an alternative embodiment of the transport hook 1. This transport hook 1 comprises a lock in the form of a free locking end 3e that is connected to the engagement section 3c.The free locking end 3e protrudes from the engagement section 3c in a direction away from the lever portion 2 and extends in the longitudinal direction of the transport hook 1.The free locking end 3e and the engagement section 3c thereby form a kind of double nose, which reliably secures the transport hook 1 in the hole 102 of the load 101 when the transport hook 1 is not or not yet subjected to a tensile force by the transport device.

FIG. 4c shows a section through the transport hook 1 of FIG. 4a without the locking device 7.In this Figure, the courses of the through holes 8 and 10 within the hook shank 3 and the retaining bracket 6, respectively, can be seen for the first time. It is obvious that the center axis A10 of through hole 10 and the center axis A8 of through hole 8 are in line, that is, the two center axes A8 and A10 coincide. This allows through holes 10 and 8 to be created in two steps from one side, starting with through hole 10. It is also possible to drill the through hole 10 and the through hole 8 simultaneously with two tools from opposite sides.

In the further, a magnet 14 is connected to the transport hook 1, for example glued on or connected by force and/or form-fit. The magnet 14 provides an additional safeguard if the load 101 to be lifted is made of magnetic material or comprises magnetic material, for example metal particles in a reinforced plastic. The magnet 14 is preferably a permanent magnet which secures the transport hook 1 on the load 101, and which is easily released from the load 101 when the load 101 is lifted at a preferably predetermined weight.

FIG. 5 shows a transport lever 1 without retaining bracket 6 for connecting to a safety device 7.To secure the transport hook 1 in a hole 102 of a load 101, the transport hook 1 comprises a locking element 5 in the area of the hook shank 3, which is connected in the swivel joint S to the engagement section 3c. The locking element 5 is elastically pretensioned in the locking position shown and can be pressed against the tension force, for example by hand, on the hook shank 3 to be inserted into the hole 102 of a load 101 together with the hook shank 3 or the engagement section 3c. When the locking element 5 has passed completely through the hole 102, it is automatically moved by the elastic force into the locking position shown, thereby securing the transport hook 1 in the hole 102 of the load 101.

FIG. 6 shows a transport lever 1 with the safety device 7 and the locking element 5, which in this case is elastically pretensioned into a release position in which it lies against the hook shank 3. From this position, it can be moved by the safety device 7 against the elastic force into the locking position shown. For this purpose, the locking rod 7c presses with the free end 7d on the locking element 5, moves it to the locking position shown and fixes it in this position.

To set the locking element 5 in the locking position, the locking rod 7c can be secured in the position shown, for example by means of a locking mechanism (not shown) via the handle 9, for example the handle 9 on the locking rod 7c can be rotated to secure it in the telescoped position. To remove the transport hook 1 from the hole 102 of the load 101, it is then only necessary to release the locking rod 7c by the handle 9. The elastic recoil force acting on the locking element 5 can then push the locking element 5 back to the release position, which simultaneously moves the locking rod 7c back into the through hole 8 when the spring force of the locking element 5 is greater than the spring force applied to the locking rod 7c.

If a locking mechanism is provided for fixing the locking part in the locking position and in the release position, then the spring for acting on the locking part 7b, 7c, 7e can be omitted completely. This applies to all the embodiments explained, since the locking part is then held in a defined manner in the locking position as well as in the release position without a spring. However, the application of a spring is advantageous since the locking part always automatically assumes a defined position. The spring can also be arranged in such a way that the locking part is pressed into the release position. In this case, however, a locking mechanism should be provided that can fix the locking part in the locking position.

A transport hook 1 according to further embodiment is formed with a movable safety lever 20 on the lever portion 2 (FIGS. 9a, 9b). The safety lever 20 is pivotally mounted by means of a swivel joint 21 adjacent to the coupling opening on the side of the lever portion 2, from which the hook shank 3 also extends away. The safety lever 20 can be folded away from the hook shank 3 a short distance until the safety lever strikes the hook shank with a stop element 22 and a further swivel movement is blocked (FIG. 9b).

In the release position (FIG. 9a), the safety lever 20 is directly connected to the lever portion 2.The transport hook 1 can thus be inserted into a hole 102 of a load 101 with the hook shank 3 and pulled out again, the lever portion 2 being arranged approximately parallel to the surface of the load 101 for this purpose.

In the locked position, the safety lever 20 protrudes from the lever portion 2 on the same side as the hook shank 3 (FIG. 9b). This allows the hook leg to engage behind an edge at the hole 102 of a load 101.The lever portion 2 cannot be moved toward the surface of the load 101, so that the transport hook 1 cannot be removed from the hole 102.

The safety lever 20 thus forms a movable locking part on the transport hook 1, which can be used to secure the transport hook to the hole 102.

The safety lever can be secured in its end positions with a corresponding fixing device. This fixing device (not shown) may comprise, for example, a spring that is arranged between the lever portion 2 and the safety lever 20 and which pushes them apart. A fixing ring can wrap around the lever portion 2 and be displaced along the lever portion so that it also encloses the safety lever 20 resting against the lever portion 2 and secures it in its position resting against the lever portion 2 (FIG. 9a).By displacing the locking ring in the direction of the hook shank 3, the safety lever 20 can be released. Latching means can also be provided in instead of the spring, or in addition to the spring, which fix the safety lever in its end positions according to FIG. 9a and/or FIG. 9b. Instead of a pivotable safety lever, another movable locking part that is not pivotable can also be provided, which can form a protrusion that can be changed by the lever portion 2.

FIG. 7 shows in drawing a) an example of a first lifting system 100 supporting a plate-shaped load 101 or a structure with a plate-shaped section. The load 101 comprises three substantially circular holes 102 with a diameter slightly larger than the diameter D of the hook shank 3 (FIG. 3) of the transport hooks 1 which engage through the holes 102 of the load 101.The transport hooks 1 can be connected by ropes or chains 103 to a lifting device 200, which is shown in drawing a) as a directional arrow. The ropes 103 can be connected directly or via a connecting element 104 to the lifting device 200, for example a crane.

Drawing a) shows a second lifting system 100 supporting a plate-shaped load 101 or a structure with a plate-shaped section. The structure 101 comprises four substantially circular holes 102 with a diameter slightly larger than the diameter D of the hook shank 3 (FIG. 3) of the transport hooks 1 which engage through the holes 102 of the load 101. The transport hooks 1 can be connected by ropes or chains 103 to a lifting device 200, which is shown in drawing b) as a directional arrow. The ropes 103 can be connected directly or via a connecting element 104 to the lifting device 200, for example a crane.

Drawing c) shows a lifting system 100 with a load 101 in the form of a box or hollow structure. In the top surface 101 of the load 101, which forms a plate-shaped section, two holes 102 are inserted in which the transport hooks 1 engage. The transport hooks 1 are connected to a lifting device 200 via ropes 103, as shown in the drawings a) and b) of FIG. 7.

In FIG. 8, four hand-drawn sketches illustrate the process steps necessary to use one or more transport hooks 1 to grip and lift a load 101 with a substantially circular hole 102 in a plate-shaped section.

Drawing a) shows the transport hook 1 with the lever portion 2 and the hook shank 3, how it is brought to the circular hole 102 of load 101, for example by hand. In drawing b) the hook shank 3 is passed through the circular hole 102 of load 101 and protrudes downwards from the plate-shaped load 101.The lever portion 2 of transport hook 1 lies substantially flat on the top surface 101a of the load 101.

In drawing c) the transport hook 1 is connected via the coupling opening 4 to a lifting device 200 shown as a directional arrow in drawing c), for example a crane, and a tensile force is applied to the transport hook 1. This causes the transport hook 1 to rotate in the hole 102 of the load 101 around a lower edge of the inner peripheral wall 104 and the hook shank 3 to be swiveled toward a rear side 101b of the load 101.The transport hook 1 assumes the position shown in drawing c) as the end position when the load 101 is lifted by one of the lifting systems 100 of FIG. 7 comprising several holes 102 and several transport hooks 1.Also drawn in the drawing c) is the straight line V connecting the point of application of the lifting device 200 to the lever portion with the vertex SP of the angle section 14.The angle α between the straight line V and a second straight line on the top surface of the hook shank is less than 90°.

In drawing d), the single transport hook 1 has been moved by the lifting device 200, shown as a directional arrow in drawing d), to an end position in which the transport hook 1 carries the weight of the load 101.The load 101 hangs downward substantially vertically from the transport hook.

In the embodiment example shown in FIGS. 8a) to 8d), the plate-shaped section of load 101 comprising the hole 102 is thin compared to the hook shank 3.In the case of a thin load 101, by which is meant that it is thin in the area of the hole 102 compared to the thickness of the hook shank 3, it is sufficient if the hole 102 is only slightly larger than the cross-sectional area or the maximum diameter D of the hook shank 3.

However, thicker loads can also be lifted with the transport hook 1.The thicker the load 101 is in the area of the hole 102, the larger the hole 102 must be to allow the hook shank 3 and the angle section 14 to be inserted into the hole 102.This also depends on how much the hook shank 3 is bent relative to the lever portion 2.

Tests have shown that the maximum hole diameter should preferably not be larger than twice the maximum diameter D of the hook shank 3, in particular not larger than 1.8 times the maximum diameter D of the hook shank 3, or not larger than 1.5 times the maximum diameter D of the hook shank 3, or not larger than 1.3 times the maximum diameter D of the hook shank 3, so that the hook shank and the angle section can be inserted into the hole, on the one hand, and cannot escape, on the other hand, when the transport hook is under tension during lifting.

The thickness of the load in the area of hole 102 is preferably not larger than 2 times the maximum diameter D of the hook shank 3, in particular not larger than 1.5 times the maximum diameter D of the hook shank 3 or not larger than 1.3 times the maximum diameter D of the hook shank 3.

To prevent accidental escape, the maximum hole diameter should be smaller than a hook shank length HSL (FIG. 3 a), which is the distance between the free end 3b of the hook shank and the side of the lever portion 2 remote from the hook shank 3.The maximum diameter of the hole is preferably smaller than 0.8 times the length of the hook shank HSL, in particular smaller than 0.7 times the length of the hook shank HSL or smaller than 0.5 times the length of the hook shank HSL or smaller than 0.3 times the length of the hook shank HSL. This limits the maximum thickness of the load in the area of the hole.

The hole 102 is preferably circular. It may also deviate from the circular shape, whereby it is functional that the smallest hole diameter does not deviate from the largest hole diameter by more than 50%, preferably not more than 25% and in particular not more than 10%.

FIGS. 10a- 10c show the transport hook 1 of FIG. 1 in a modified form. The transport hook 1 comprises the lever portion 2 with the coupling opening 4 and the hook shank 3 which can engage through a hole 102 of a load 101 (both not shown) to lift and transport the load 101 by means of a lifting system 100 (not shown).The transport hook 1 comprises a safety device with which it can secured in the hole 102 or is secured when the transport hook 1 is subjected to a tensile force by the lifting system 100, so that the transport hook 1 cannot be unintentionally moved out of the hole 102 when the safety device is active.

To prevent the transport hook 1 from being inserted too deep into the hole 102, the transport hook 1 comprises a wing element 18, which may comprise two separate wings 18.1 and 18.2.The wing element 18 is connected to the transport hook 1 at a rear side 2b of the transport hook 1 facing the hook shank 3, preferably firmly connected by means of adhesion, a material-or force-fitting manner, etc. The wings 18.1.18.2 project laterally from the transport hook 1 in a view from above of the transport hook 1 as shown in FIG. 10a).The transport hook 1 has a diameter D in the area where the wing element 18 or - the wings 18.1, 18.6 is/are connected to the transport hook 1 (see FIG. 2).For example, the distance AFF between the outer ends 18.1a, 18.2a, the ends pointing away from the transport hook 1, can then correspond approximately twice the diameter D of the transport hook 1 in this area. However, the distance AFF can also be larger or smaller. The distance AFF can also be referred to as the span width of the wing element 18.

The wing element 18, when connected to the transport hook1 as shown, may protrude below the lower surface 2b of the lever portion 2 or the transport hook 1 in the vicinity of the connection area with the wing element 18, or may be arranged in a recess not explicitly shown, so that the wing element 18 does not protrude above the rear side of the transport hook 1, but is preferably planar with the surrounding surface of the transport hook 1.

The transport hook 1 further comprises a nose 23 formed on a top surface of the transport hook 1.In the embodiment shown, the nose 23 protrudes in a dormer shape from the top surface 2c facing away from the hook shank 3.The nose 23 comprises a planar front panel 23a facing the retaining bracket 6, which in the embodiment example shown is substantially parallel to the outer surface 6b of the retaining bracket 6 facing the nose 23.

The nose 23 is connected to the transport hook 1 in the area where there is an opening of the through hole 8, which forms an opening and guide for the locking rod 7c in the angle section 14.The nose 23 extends the through hole 23 and the front panel 23a advantageously forms a flat attachment surface for a drill for creating the through hole 8 in the angle section 14 of the transport hook 1.At the same time, the nose extends the guide area for the locking rod 7c and the locking rod 7c is better protected in the extended through hole 8.

The top surface of the nose 23 can run parallel to a central longitudinal axis of the locking rod 7c that is not shown. The height HN of the nose 23 in the area of the front panel 23a perpendicular to the central axis of the locking rod 7c can be selected in such a way that the nose 23 completely covers the handle 9 in a front view of the transport hook 1.This prevents the handle 9 from being unintentionally released from the locking position shown when the load is being picked up or transported. Thus, the last-described nose 23 reliably prevents, for example, a rope of the lifting system 100 or an unevenness of the load 101 from unintentionally moving the handle and thus no longer ensuring the safety of transport.

At its end facing the angle section 14, the nose 23 may have a distance NT from a tangent T, which bears against the surface of a leading end of transport hook 1, which distance depends on the diameter D of the hook shank 3 and/or the angle section 14.The distance NT can preferably be approximately twice the diameter D. However, the distance NT can also be smaller or larger than twice the diameter.

As shown in FIG. 10b, the height HN of the front panel 23a can be determined by an extension part 24, which is part of the nose 23 and is pre-formed together with the nose 23 or formed separately to the nose 23 and subsequently connected to the nose 23.In the latter case, the extension part 24 can be formed of a material different from the material of the nose 23, for example a plastic, and can be replaced in case of wear or damage.

The nose 23 can also comprise a locking element, be means of which the locking rod 7c can be secured in the locking position and preferably also in the rest position. For example, this locking element can be a slider that engages or latches into recesses on the locking rod 7c.In a solution, the extension 24 can form the locking element. Other known mechanisms for securing the locking rod 7c in fixed positions relative to the through hole 8 are included in the invention. With such a solution, the retaining bracket 6 can be omitted altogether, resulting in material savings and cost savings. FIG. 10b shows an embodiment in which handle 9 forms the end of the locking rod 7c.

Even if this is not explicitly shown in FIG. 10b, the retaining bracket 6 can be formed in a plate-like shape with a thickness in the longitudinal direction of transport hook 1 that is substantially smaller than that as shown in FIG. 10b, for example a steel plate with a thickness of 3 mm or 0.5 cm or 1 cm or some other dimension. In this case, the spring element not shown, which pretensions the locking rod 7c into the locking or resting position, would be arranged outside the retaining bracket 6 and would bear with one end against an outer side of the retaining bracket and with the other end against the handle. The spring is preferably a coil spring which encloses the locking rod 7c.In this embodiment, there is no requirement for a mounting plate 7a as provided for in the embodiments explained above. The spring element can be protected against contamination by an elastic sleeve.

Reference list:

| | |
|---|---|
| 1 | Transport hook |
| 2 | Lever section |
| 2 a | free end |
| 2B | Rear side |
| 2 c | Surface |
| 3 | Hook shank |
| 3 a | Intervention section |
| 3 b | free end |
| 3 c | Free fuse end |
| 4 | Coupling aperture |
| 4A | Plate center |
| 5 | Fuse element |
| 6 | Retaining plate |
| 6 a | Receiver |
| 6 b | Outer surface |
| 7 | Connecting device |
| 7 a | Mounting plate |
| 7 b | Hollow cylinder |
| 7 c | Locking rod |
| 7 d | free end |
| 7 e | lock nut |
| 8 | Through hole |
| 9 | Handle bar |
| 10 | Through hole |
| 11 | Attachment point |
| 12 | Hole wall |
| 13 | Coating |
| 14 | Angle section |
| 15 | Engaging portion |
| 16 | flattened surface |
| 17 | Edge |
| 18 | Blade element |
| 18.1a | Blade tip |
| 18.2 | Blades |
| 18.2a | Blade tip |
| MLE | Median Longitudinal Plane |
| A8 | Center axis |
| A10 | Center axis |
| α | Angle |

1. A transport hook for lifting and moving a load comprising
a plate-shaped section in which a hole is formed,
wherein the transport hook comprises a substantially straight lever section with a coupling element with which the transport hook can be connected to a lifting device, and
comprises a substantially approximately straight hook shank,
wherein the hook shank is connected with an angle section to the lever portion in such a way that an angle is formed between a line extending from the coupling element to a vertex located on the inner surface of the angle section and a line extending along the hook shank, which is smaller than 90°, the hook shank and the angle section forming a continuous strand of approximately uniform thickness so that, for lifting and moving a load, the hook shank and the angle section can engage in the hole of the load and the hook shank or the angle section can engage behind an edge of the hole.

2. The transport hook according to claim 1,
wherein the transport hook comprises a lever section with a coupling element with which the transport hook can be connected to a lifting device, and
comprises a hook shank which can engage in a hole of the load for lifting and moving the load,
wherein at least the hook shank is a round structure comprising a substantially round cross-section.

3. The transport hook according to claim 1,
wherein the coupling element is formed as a coupling opening on the lever portion and/or the coupling means is arranged on the free end of the lever portion facing away from the hook shank.

4. The transport hook according to claim 1, wherein the transport hook is formed in one piece by cast, pressed from a powder, machined from a solid material or forged from a semi-finished product.

5. The transport hook according to claim 1, wherein the lever portion is plate-shaped, comprising a length (L) that is many times greater than a width (B) or thickness (H) of the lever portion.

6. The transport hook according to claim 1, wherein the hook shank is connected to the lever portion 2 by an angle section, which is formed adjacent to the angle section with an engagement area, wherein the engagement area, the angle section and the hook shank are each formed as a round structure with a substantially round cross-section.

7. The transport hook according to claim 6, wherein the diameter (D) of the engagement area, the angle section and the hook shank are substantially equal to the thickness (H) of the plate-shaped lever portion.

8. The transport hook according to claim 1, wherein a width (B) of the lever portion at a free end facing away from the hook shank is larger than a width (B) of the lever portion adjacent to the hook shank.

9. The transport hook according to claim 1, wherein the lever portion is many times longer than the engagement section of the hook shank.

10. A transport hook for lifting and moving a load according to claim 1,
wherein the transport hook comprises a lever portion with a coupling element (4), via which the transport hook can be connected to a lifting device, and a hook shank that can engage through a hole of the load, wherein the hook shank is connected with an angle section to the lever portion, wherein
a safety device is provided that comprises a locking part movably arranged on the transport hook in such a manner that it can form a protrusion on the hook shank so that a hook shank engaged through the hole can no longer escape from the hole.

11. The transport hook according to claim 10,
wherein the locking part is loaded by means of a spring so that it can be moved against the resilience in such a way that it does not form a protrusion on the hook shank and the latter can be pulled out of the hole.

12. The transport hook according to claim 10, wherein the locking part comprises a locking rod, which is slidably mounted on the transport hook in the longitudinal direction.

13. The transport hook according to claim 10 wherein the lever portion comprises a retaining bracket, which is designed to retain the safety device.

14. The transport hook according to claim 10 wherein the angle section has a through hole, which forms a guide for the locking part.

15. The transport hook according to claim 10 wherein the locking part comprises a handle for actuating the locking part, wherein the handle can also be designed as a stop for fixing one or both end positions of the movable locking part.

16. The transport hook according to claim 14
wherein a latching mechanism is provided to releasable fix the movable locking part in one of its end positions.

17. The transport hook according to claim 1, wherein the transport hook comprises a locking element that secures the transport hook in the hole of the load.

18. The transport hook according to claim 17, wherein the locking element is connected to the hook shank in a swivel joint and is preferably elastically pretensioned into a locking position in which it protrudes from the hook shank, or into a position in which it rests against the hook shank.

19. The transport hook according to claim 17,
wherein the locking element is adapted to lay against a surface of the hook shank when the engaging section is engaged through the hole of the load and elastically swivels to the locking position after engaging through the hole.

20. A lifting system for lifting and moving a load comprising a single or at least two substantially circular holes within a top surface of the load, the lifting system comprising:
a single or two or more transport hooks, according to claim 1,
wherein each of the transport hooks is connected to a rope or a chain and the ropes or chains are positioned at an end facing away from the transport hook so that they can be connected to a gripper of the lifting device.

21. A method of lifting and moving a structure comprising at least one hole within a plate-shaped section on a top surface of the load with at least one transport hook, comprising a hook shank, an angle section and a lever portion and the transport hook according to claim 1,
wherein a hook shank of the transport hook is inserted through the preferably circular hole,
an end of the lever portion remote from the hook shank with a lifting device with a tensile force, with a force vector loaded in a direction away from the hole,
whereby the hook shank or the angle section are inserted into the circular hole and engage behind an edge of the hole to lift the structure.

22. The Method according to claim 21, characterized in that
the diameter of the circular hole corresponds at least to the thickness of the plate-shaped section.

23. The method according to claim 21 wherein
- the load in the area of the hole has a thickness that is smaller than twice the maximum diameter of the hook shank, and/or
- a maximum hole diameter that is not larger than twice the maximum diameter of the hook shank, and/or
- that the maximum hole diameter is smaller than a hook shank length (HSL), and/or
- the hole is oval and, in particular, approximately circular.
